(19) United States
(12) Patent Application Publication
(10) Pub. No.: US 2026/0027478 A1
(43) Pub. Date: Jan. 29, 2026

(54) DRIVING SIMULATION SYSTEM

(71) Applicant: Strelar, Inc., Bronx, NY (US)

(72) Inventors: Marek MILTNER, Palo Alto, CA (US); Derrick Harry LEWIS, New York, NY (US)

(21) Appl. No.: 18/787,684

(22) Filed: Jul. 29, 2024

(51) Int. Cl. A63F 13/803; A63F 13/577

(52) U.S. Cl. CPC A63F 13/803; A63F 13/577

(57) ABSTRACT

A system and method for simulating a driving experience, such as a racing experience, for a driver of a real-world vehicle is described. The system and method may combine or integrate actions within an augmented reality (AR) environment presented to the driver via a helmet or other virtual user interface (VUI) with movement and/or operation data to anticipate or simulate the effects of virtual vehicle collisions when the driver is operating the vehicle.

### BACKGROUND

The opportunity to drive a car on a racetrack has long been an expensive endeavor. For example, a person can utilize a racing experience service, which can put the person in a modified race car and, often, enable the person to drive a series of laps around a racetrack (e.g., for a fee). However, this experience may only allow for one vehicle at a track, and, for many reasons, generally does not allow people to race one another, other than in specific, tightly controlled, racing environments, which can come at significant additional costs.

Moving to the virtual world, video games and racing simulators have long provided users with racing experiences. For example, video games enable users to compete with one another via virtual races. Racing or driving simulators attempt to provide more realistic experiences. These simulators can provide realistic controls (e.g., cockpits), haptic responses, and more immersive environments.

However, neither the real-world experiences nor the virtual world experiences effectively provide users with realistic racing experiences, among other drawbacks.

### BRIEF DESCRIPTION OF THE DRAWINGS

Embodiments of the present technology will be described and explained through the use of the accompanying drawings.

FIG. 1 is a diagram illustrating a suitable computing environment that supports a driving simulation system.

FIG. 2 is a block diagram illustrating various components of a vehicle and an associated virtual user interface (VUI).

FIG. 3 is a flow diagram illustrating a method for simulating a driving action via a vehicle driven by a user.

FIG. 4 is a flow diagram illustrating a method for instructing a vehicle driven by a user to perform an operation associated with a simulated driving action.

FIG. 5 is a diagram illustrating a virtual driving environment displayed to a driver of a vehicle.

FIGS. 6A-6B are diagrams illustrating a simulated collision within a displayed virtual driving environment.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

### Overview

A system and method for simulating a driving experience, such as a racing experience, for a driver of a real-world vehicle is described. The system and method may combine or integrate actions within an augmented reality (AR) environment presented to the driver via a helmet or other heads-up-display (HUD) (e.g., a VUI) with vehicle movement and/or operation data to anticipate or simulate vehicle collisions when the driver is operating the real-world vehicle.

For example, a driving simulation system presents an augmented or other virtual environment to a driver of a vehicle via a HUD or other display displayed within the drivers' field of view. The virtual environment presents a racetrack or course, through which the driver moves their vehicle, as well as virtual objects (e.g., other cars, track objects, road objects, and so on). The driver, therefore, operates their vehicle on a real-world track or course (e.g., the ground truth operation of the vehicle) while simultaneously moving (e.g., racing) within the displayed virtual environment (e.g., virtual operation within a simulated racetrack with other drivers).

In some embodiments, the driving simulation system determines or identifies a virtual collision has or will occur within the displayed simulation and activates a steering and braking system to perform a responsive action. For example, the system may cause the vehicle to perform a controlled acceleration or deceleration via the brakes of the vehicle and/or change the direction of the vehicle by moving, slightly, the steering wheel (or tires of the vehicle) in either direction. The driving simulation system can act as an interface between the simulated driving experience (displayed by the driver's helmet or a similar VUI) and the actual driving experience within the vehicle by causing the driver to experience physical forces (e.g., braking or steering forces) reactive to simulated driving actions or events.

As described herein, aspects of the technology refer to a vehicle driven by a user (e.g., a driver of the vehicle). As such, a vehicle may include a car (e.g., a race car), a truck, a boat, an airplane, a sled, and so on. Similarly, other machines that transport or convey people, such as bicycles, skateboards, watercrafts, and so on, may employ aspects of the technology and/or be considered a vehicle that applies forces or operations responsive to simulated movements or actions.

Thus, the technology, in various embodiments, combines the real world and the virtual world by providing a full sensory experience of driving at a real track in a vehicle while enhancing the driver's view in real time. These enhancements, via presented virtual elements, provide the driver with live performance information, simulated racing conditions, and affect vehicle dynamics to enable and provide an interactive racing experience.

Various embodiments of the technology will now be described. The following description provides specific details for a thorough understanding and an enabling description of these embodiments. One skilled in the art will understand, however, that these embodiments may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments.

### Examples of a Suitable Computing Environment

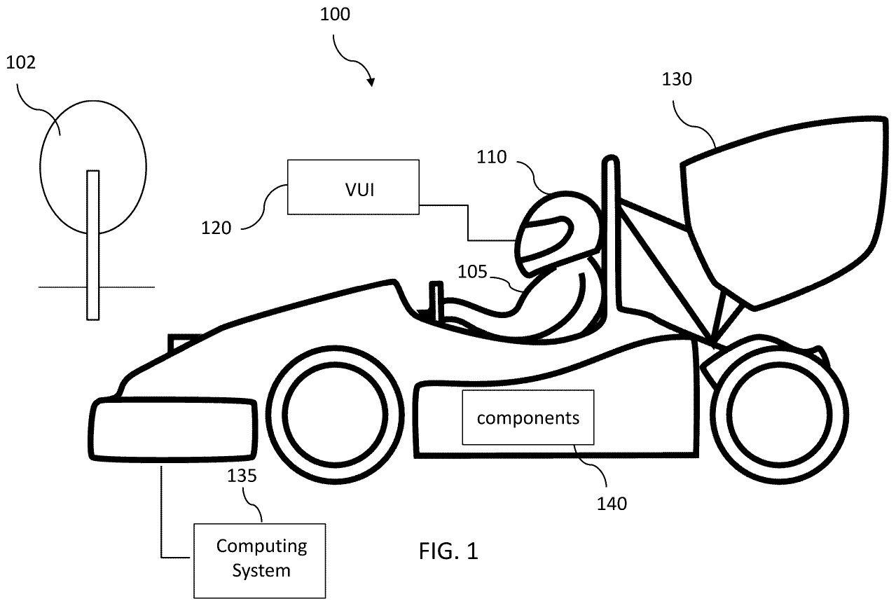

As described herein, the driving simulation system may facilitate the integration of simulated actions or events within a virtual racing environment with responsive operations performed by a vehicle driven by a user viewing the virtual racing environment. FIG. 1 is a diagram illustrating a suitable computing environment 100 that supports a driving simulation system.

FIG. 1 is a diagram illustrating a suitable computing environment 100 that supports a driving simulation system. The computing environment 100 includes a driver 105 of a vehicle 130, such as race car or another type of vehicle. The vehicle 130 may be moving through a physical racing environment, such as a real-world racetrack 102 or location that provides racing or driving tracks or courses. Such movement may be a ground truth movement or reality for the vehicle 130 within the real-world environment, such as the racetrack 102.

The driver 105 is wearing a helmet 110, which includes a virtual user interface (VUI) 120, such as a HUD, configured to present a virtual environment via augmented reality to the driver 105 while driving the vehicle 130. The helmet 110 may include a computing system, such as a system having a CPU and memory, as well as a display. The display may include a projected display, a HUD, and so on. Further, in some cases, the vehicle 130 may include some or all aspects of the computing system and may be communicatively coupled to the VUI 120.

For example, the helmet 110 may include a visor composed of protective glass and/or an LED or other interactive display. The visor and/or display may present the virtual environment of the VUI 120 (e.g., via projections of images onto the visor). Thus, the visor may display the virtual environment and/or other information in real-time as a layer over a real-world view of the driver 105. The virtual environment may be presented as or via a virtual reality (VR) experience, an augmented reality (AR) experience, or other extended reality (XR) experiences, (e.g., in addition to the visualized aspects of the experience).

The vehicle 130 includes a computing system 135 and various vehicle components 140, such as components manipulated by the driver 105 when driving the vehicle 130. For example, the vehicle components 140 may include a braking system, where the driver 105 interacts with brake pedals or other brakes to modify a speed (e.g., slow down or speed up) of the vehicle 130. As another example, the vehicle components 140 may include a steering mechanism or system, where the driver 105 interacts with a steering wheel to modify a direction of motion or movement of the vehicle 130.

In some cases, the steering mechanism may include a steering wheel that directly connected to the wheels of the wheel, a drive-by-wire system, or other mechanical architectures.

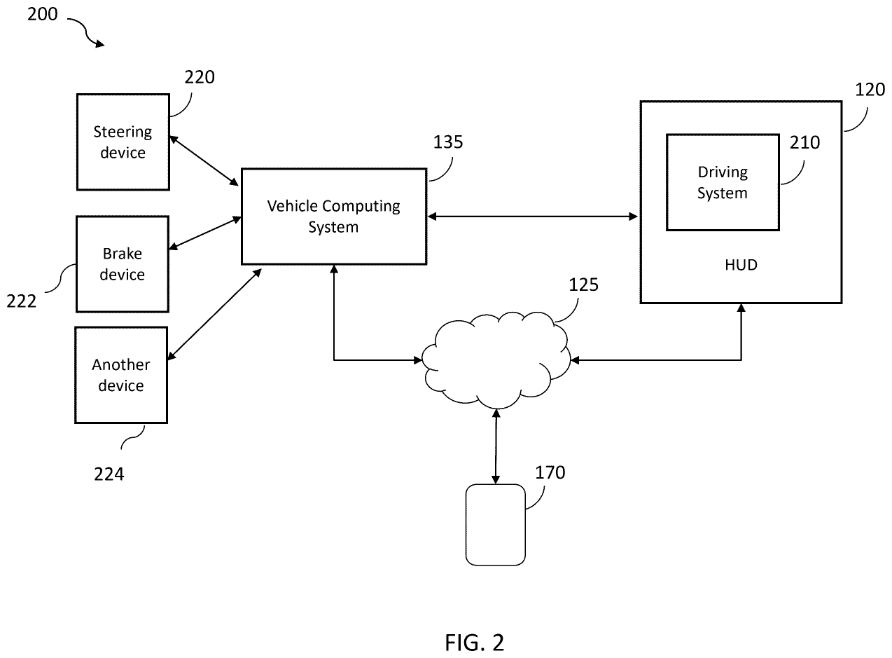

FIG. 2 is a block diagram illustrating various components 200 of the vehicle 130 and associated virtual user interface (VUI) 120. The VUI 120 includes a driving system 210, such as a virtual driving system 210. The virtual driving system 210, in some embodiments, presents a virtual racing environment to the driver 105 of the vehicle 130 via the VUI 120. The virtual racing environment can include a racetrack via which the driver 105 of the vehicle 130 moves within the virtual racing environment, such as via an avatar representing the vehicle 130 and/or within the field of view of the driver 105 (where the driver 105 and vehicle 130 are not displayed by the virtual racing environment.

The virtual driving system 210 may also display and present virtual objects within the virtual racing environment. These virtual objects may include other vehicles (e.g., other vehicles racing the driver 105 within a racetrack or course displayed within the virtual racing environment), racetrack objects or elements (e.g., side walls of the racetrack, road objects, and so on), and so on.

Further, the virtual driving system 210 may present objects projected on top of or layered into a real environment surrounding the driver (e.g., for XR/AR experiences), such as an environment viewed by the driver via the windshield (or windows) of the vehicle.

In some cases, the virtual driving system 210 may determine occurrences of virtual actions associated with the driver 105 of the vehicle 130 within the virtual racing environment. As described herein, the system 210 may predict and/or determine the vehicle 130, within the virtual racing environment, is going to collide with an object (e.g., another vehicle, a wall or curb of the virtual racetrack, and so on). In response to the prediction or determination of the virtual action, the system 210 may transmit instructions or other information to the vehicle 130, such as to the computing system 135 of the vehicle.

The driving system 210 and the computing system 135 of the vehicle 130 may communicate with one another via a network 125 and/or via various direct or short-distance wired or wireless protocols. For example, the communications may include various wired communication protocols, such as via ethernet or CAN bus, or wireless communication protocols, such as cellular communication, Bluetooth® communication, Near-Field Communication (NFC), Radio Frequency Identification (RFID) communication, and/or other communication protocols described herein.

The computing system 135 of the vehicle 130, as described herein, may interact with various vehicle components 140, such as braking systems, steering mechanisms, and so on. For example, the computing system 135 may cause a steering device 220 associated with a steering wheel to move in response to a virtual or simulated action, may cause a brake device 222 associated with the brakes of the vehicle 130 to be applied or modified in response to a virtual or simulated action, and/or may cause another device 224 to be modified in response to the virtual or simulated action.

In some embodiments, the virtual driving system 210 and/or the computing system 135 may communicate with a mobile device 170 or another computing system (e.g., a remote server) to provide information about a virtual racing environment, actions performed within the environment, and/or operations that were modified for the vehicle 130. The mobile device 170 may include a software application that tracks and presents data about the driver's experience. For example, during a virtual race, the application may track and/or present information about the racetrack, the speed, lap times, or other race information or driving statistics. The application may rank drivers, award drivers, provide comparisons between the driver 105 and other drivers or between different races of the driver 105 (e., PRs for different races, courses, laps, and so on).

In some cases, the application may enable the driver 105 to access or download performance data, such as track maps, weather and track conditions, professional driver performance data, lap times, aerodynamics, and other performance indicators. The virtual driving system 210 may utilize such data to generate opponents based on professional drivers, to simulate realistic experiences or specific racing events (e.g., replicating weather and track conditions), train or level up opponents, and so on.

For example, the driver 105, via the application and/or the system 210, may select a track map (e.g., the Nürburgring) as the virtual racing environment. The virtual driving environment may also depict weather conditions by using graphics or symbols. In some cases, the simulated weather conditions (e.g., high winds) may cause forces to be applied to the driver 105 via the vehicle components 140 (e.g., simulating the vehicle 130 drifting from the winds) against the vehicle 130.

The application may also track vehicle performance data, such as data that tracks and depicts the real-world driving of the vehicle 130 with respect to a virtual race. The data can indicate when corrective operations occurred, can map virtual actions (e.g., collisions) to real-world locations of the physical racecourse, and so on.

FIGS. 1, 2, and the components depicted herein provide a general computing environment and network within which the technology can be implemented. Further, the systems, methods, and techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical discs, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

A network, such as the network 125, can be any network, ranging from a wired or wireless local area network (LAN), to a wired or wireless wide area network (WAN), to the Internet or some other public or private network. While the connections between the various devices and the network and are shown as separate connections, these connections can be any kind of local, wide area, wired, or wireless network, public or private.

Further, any or all components depicted in the Figures described herein can be supported and/or implemented via one or more computing systems or servers. Although not required, aspects of the various components or systems are described in the general context of computer-executable instructions, such as routines executed by a general-purpose computer, e.g., mobile device, a server computer, or personal computer. The system can be practiced with other communications, data processing, or computer system configurations, including: Internet appliances, hand-held devices (including tablet computers and/or personal digital assistants (PDAs)), all manner of cellular or mobile phones, multi-processor systems, microprocessor-based or programmable consumer electronics, set-top boxes, network PCs, mini-computers, mainframe computers, AR/VR devices, and the like. Indeed, the terms “computer,” “host,” and “host computer,” and “mobile device” and “handset” are generally used interchangeably herein and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Portions of the system may reside on a server computer, while corresponding portions may reside on a client computer such as a mobile or portable device, and thus, while certain hardware platforms are described herein, aspects of the system are equally applicable to nodes on a network. In an alternative embodiment, the mobile device or portable device may represent the server portion, while the server may represent the client portion.

### Examples of the Virtual Driving System

As described herein, in some embodiments, the virtual driving system 210 enables the integration of an AR driving experience (e.g., racing a car within a virtual racetrack) while operating a real-world vehicle (e.g., driving a race car on a track or racecourse).

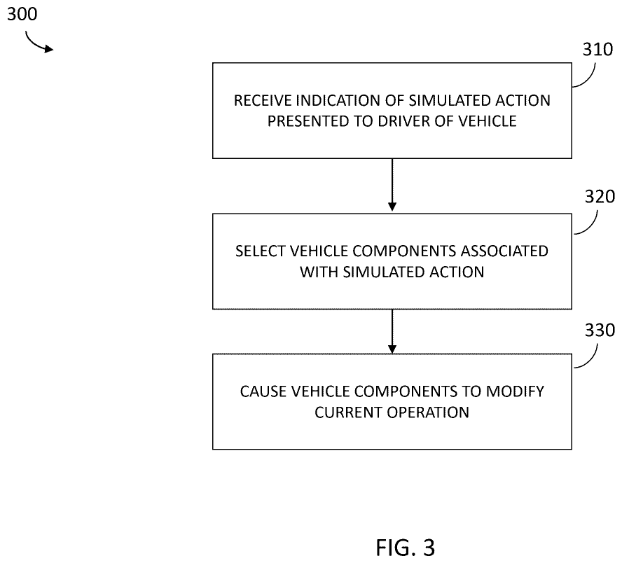

FIG. 3 is a flow diagram illustrating a method 300 for simulating a driving action via a vehicle driven by a user. The method 300 may be performed by the computing system 135 of the vehicle 130 and, accordingly, is described herein merely by way of reference thereto. It will be appreciated that the method 300 may be performed on any suitable hardware.

In operation 310, the computing system 135 receives an indication of a simulated or virtual action presented to a driver of a vehicle. For example, the computing system 135 may receive instructions from the virtual user interface (VUI) 120 worn by the driver 105 of the vehicle 130.

In operation 320, the computing system 135 selects one or more vehicle components associated with the simulated or virtual action. For example, the computing system 135 may select the steering device 220 and/or the brake device 222 based on the received indication, such as based on a type or timing of the simulated action within a virtual racing environment.

In operation 330, the computing system 135 causes the selected vehicle components to modify their current operation. For example, the computing system 135 modifies operations of the braking device 222 or the steering device 220 to simulated or represent a collision (the simulated action) within the virtual racing environment.

As an example, the driver 105 of the vehicle 130 is driving along a real-world racetrack and viewing a virtual racing environment as an AR overlay projected onto the visor of their helmet 110. In the virtual scene, the driver moves close to a wall or barrier within the virtual race. The VUI 120 of the helmet 110 sends an indication of the virtual action to the computing system 135 of the vehicle 130, along with instructions to steer (slightly) the vehicle 130 away from the virtual wall. The computing system 135 receives the instructions and sends a control command to the steering device 220 to cause the steering wheel (along with other force feedback) to move in a direction in the real-world that mimics movement of the vehicle 130 away from the virtual wall within the virtual racetrack.

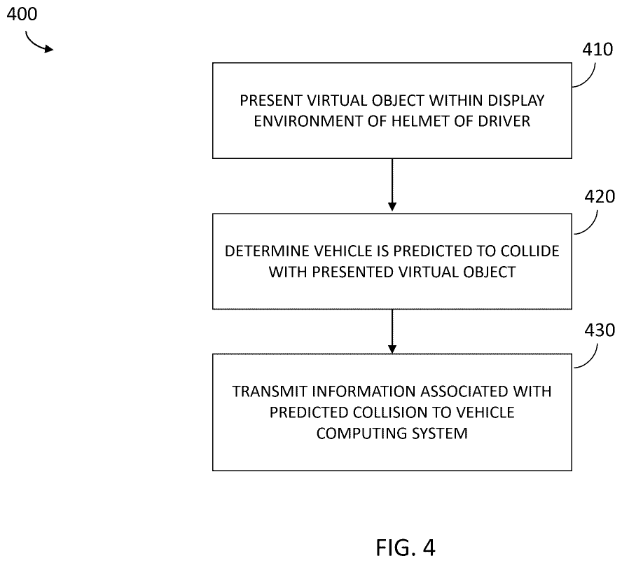

As described herein, the virtual driving system 210 determines occurrences of virtual actions within a virtual environment, such as a virtual racing environment. FIG. 4 is a flow diagram illustrating a method 400 for instructing a vehicle driven by a user to perform an operation associated with a simulated driving action. The method 400 may be performed by the virtual driving system 210 of the VUI 120 and, accordingly, is described herein merely by way of reference thereto. It will be appreciated that the method 400 may be performed on any suitable hardware.

In operation 410, the virtual driving system 210 presents a virtual object within a display environment of an augmented reality display presented to the driver of the vehicle via the VUI. For example, the virtual driving system 210 may present one or more virtual race cars within or proximate to a virtual racetrack via which the driver 105 of the vehicle 130 is traveling (e.g., racing around the virtual racetrack). In some cases, the vehicle 130 may be represented by an avatar or similar representation within the virtual racetrack.

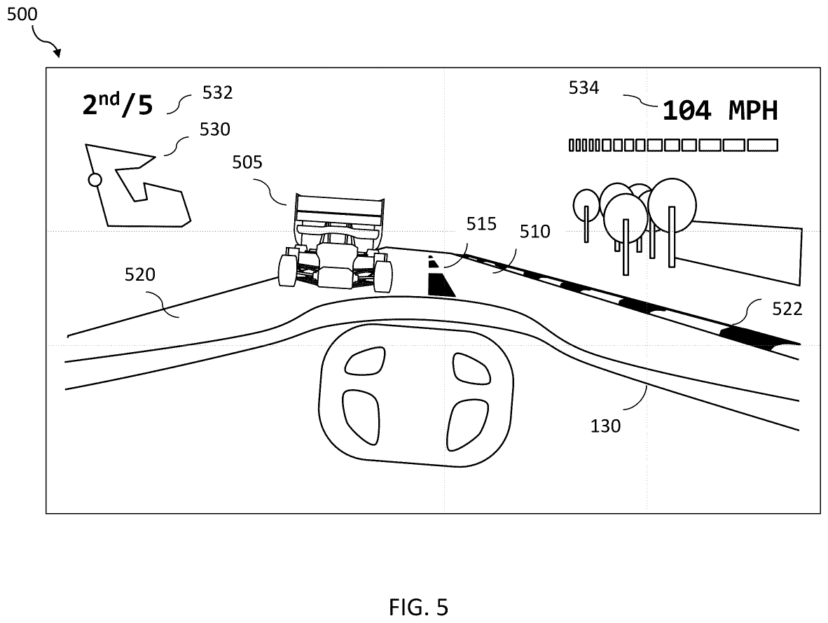

FIG. 5 depicts a virtual driving environment 500 displayed to the driver 105 of the vehicle 130. The virtual driving environment 500 depicts the view of the driver 105, displayed (e.g., presented, projected, and so on) via the VUI 120. The virtual driving environment 500, such as the information displayed, updates in real-time, or near real-time, based on how the AR experience is presented to the driver 105.

In some cases, another race car 505 (e.g., an opponent, virtual or real) is driving along a racetrack 510 with the driver 105 of the vehicle 130. The racetrack 510 can include projected apex lines 515, which show an ideal driving path or route, speed regions 520, walls 522 (or barriers or boundaries) of the racetrack 510, and so on. Further, the displayed view may present a race or track map 530, race position information 532, current (or virtual speed) 534, and so on.

Back to FIG. 4, in operation 420, the virtual driving system 210 determines the vehicle is predicted to collide within the virtual object within the display environment. For example, the system 210 may determine the vehicle is predicted to collide with the other race car 505 and/or the walls 522 of the racetrack 510.

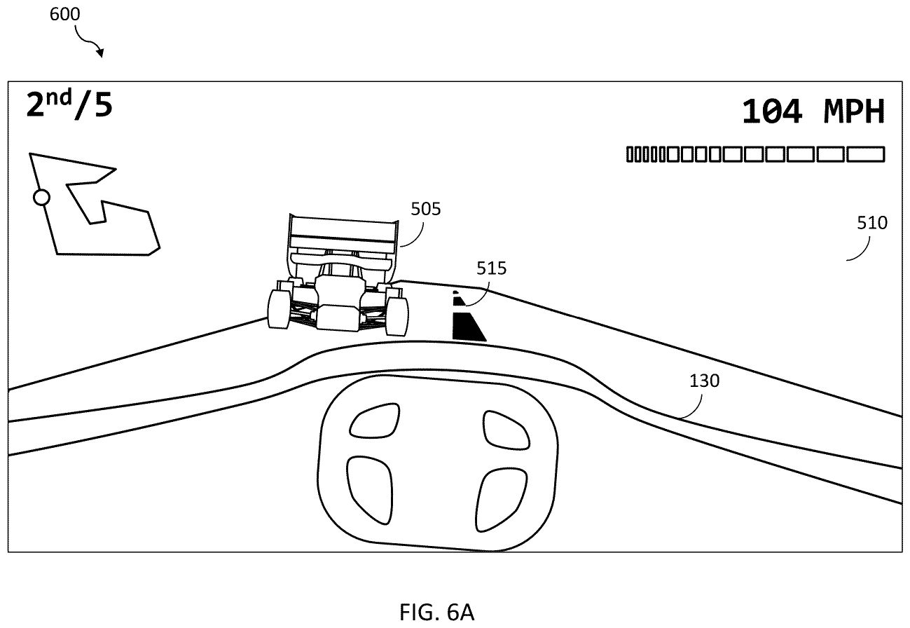

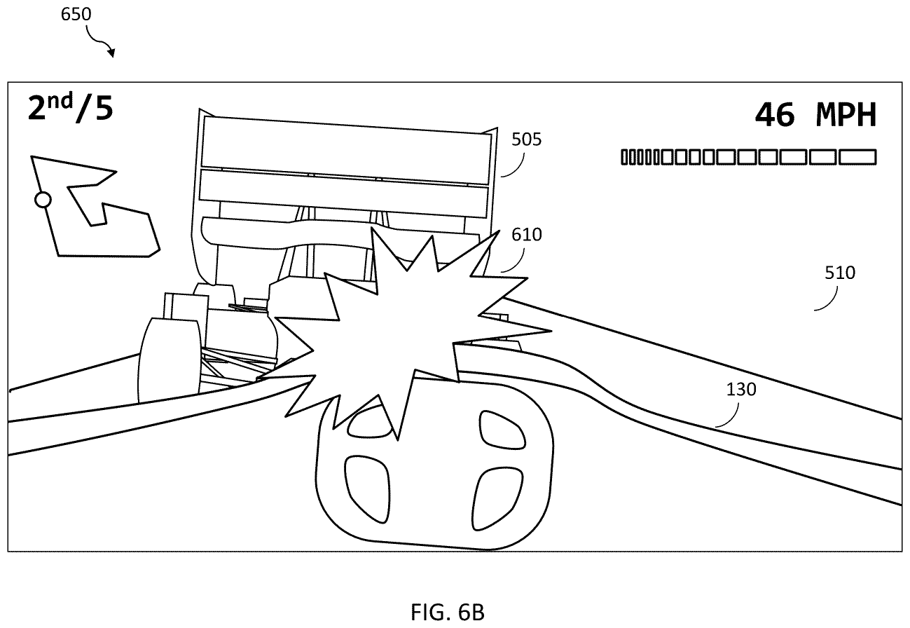

FIGS. 6A-6B depict a simulated collision 600 within a displayed virtual driving environment. In FIG. 6A, the vehicle 130 travels along the apex lines 515 within the virtual racetrack 510. The other race car 505 travels in front and to the left of the vehicle. In such a scenario, the driver 105 is operating the vehicle 130 in an optimal fashion, and no virtual action is predicted or determined.

However, FIG. 6B depicts the vehicle 130 about to collide with the race car 505. For example, the vehicle 130 has moved off the apex lines 515 and is rapidly approaching the race car 505. The system 210, in such a scenario, determines the vehicle 130 is predicted to collide within the race car 505 within the virtual driving environment, and presents a graphical element 610 representing the collision (or imminent collision).

Back to FIG. 4, in response to the predicted collision between the vehicle and the virtual object, the virtual driving system 210, in operation 430, transmits information associated with the predicted collision to a computing system of the vehicle 130. For example, the system 210 determines an imminent collision within the virtual driving environment and sends an indication to the computing system 135 of the vehicle 130. As described herein, the computing system 135 may cause vehicle components to respond to the simulated collision, such as by applying forces to the driver 135 that emulate or are responsive to a simulate collision (or bumping) with the race care 505.

As an example, the system 210, in response to a detected or predicted collision, transmits information about the predicted collision (in the virtual racing environment), such as speed, force, trajectory, direction, weight of the other race car 505, and so on.

The vehicle 130 (as described in FIG. 3) uses the brake device 220 to apply short pulses, long steady pulses, or other brake patterns to simulate a sudden collision or other collision type (e.g., bumping). Similarly, the vehicle 130 may modify the steering device 220 in a sudden, slow, or steady manner to adjust the trajectory or direction of movement of the vehicle 130 (e.g., as if it had been struck by the virtual race car 505).

Thus, the virtual driving system 210 may enable the driver 105 of an actual vehicle to feel the forces of various racing actions viewed via an integrated AR experience. The racing actions, as described herein, may include:
Bumping or colliding with another vehicle during a virtual race;
Bumping or colliding with a wall or barrier of a racetrack during the virtual race;
Adjusting to various aspects of a road surface or track of the racetrack during the virtual race;
Activating an automated, or remote-activated, slow-down or stopping of the vehicle; and so on.

In some cases, once the vehicle 130 performs an operation (e.g., braking or steering), the virtual driving system 210 may update the virtual driving environment to reflect the operation (or result). For example, the virtual driving environment may then present a post collision or post avoidance environment, where the driver is moving through the environment at a different orientation, speed, direction, or proximity to the other objects, and so on.

Thus, in various embodiments of the technology described herein, a driver of a vehicle can experience a more realistic racing experience by interacting with virtual objects (e.g., other vehicles on a racetrack) of a virtual environment and feeling forces, applied by the vehicle, that are synced or associated with actions within the virtual environment, among other benefits.

### Example Embodiments of the Technology

As described herein, the technology can include various embodiments of the virtual driving system, as follows:

In some embodiments, a driving simulation system includes a virtual racing module that is configured to present a virtual racing environment to a driver of a real-world vehicle, where the virtual racing environment includes a racetrack via which the driver of the real-world vehicle moves within the virtual racing environment, present one or more virtual objects within the virtual racing environment, and determine occurrences of virtual actions between the driver of the vehicle and the virtual objects within the virtual racing environment, and a vehicle operation module that is configured to modify operation of the real-world vehicle in response to an occurrence of a virtual action within the virtual racing environment.

In some cases, the one or more virtual objects include avatars representing virtual vehicles also moving via the racetrack within the virtual racing environment, and the occurrence of the virtual action within the virtual racing environment includes a virtual collision between the driver of the vehicle and one of the avatars representing virtual vehicles.

In some cases, the one or more virtual objects include displayed objects representing portions of the racetrack within the virtual racing environment, and the occurrence of the virtual action within the virtual racing environment includes a virtual collision between the driver of the vehicle and one of the displayed objects representing the portions of the racetrack.

In some cases, the virtual racing module determines an occurrence of a virtual action when the driver of the vehicle moves away from an apex line displayed on the racetrack via which the driver of the vehicle moves within the virtual racing environment.

In some cases, the virtual racing module determines an occurrence of a virtual action when the driver of the vehicle within a threshold distance to one or more virtual objects within the virtual racing environment.

In some cases, the vehicle operation module causes a braking function of the vehicle to slow a current speed of the vehicle in response to the occurrence of the virtual action within the virtual racing environment.

In some cases, the vehicle operation module causes a steering function of the vehicle to adjust a direction of movement of the vehicle in response to the occurrence of the virtual action within the virtual racing environment.

In some cases, the vehicle operation module causes a steering function of the vehicle to adjust a direction of movement of the vehicle and a braking function of the vehicle to slow a current speed of the vehicle in response to the occurrence of the virtual action within the virtual racing environment.

In some cases, the virtual racing module is part of a helmet worn by the driver of the vehicle that presents the virtual racing environment as an augmented reality experience via a heads-up-display supported by the helmet.

In some cases, the vehicle operation module is part of a computing system of the vehicle.

In some embodiments, a method performed by a virtual user interface (VUI) interacted with by a driver of a vehicle includes presenting a virtual object within a display environment of an augmented reality display presented to the driver of the vehicle via the VUI, determining the vehicle is predicted to collide within the virtual object within the display environment, and in response to the predicted collision between the vehicle and the virtual object, transmitting information associated with the predicted collision to a computing system of the vehicle.

In some cases, the display environment includes a racetrack via which the driver of the vehicle moves; and wherein the virtual object is another vehicle moving within the racetrack.

In some cases, the display environment includes a racetrack via which the driver of the vehicle moves; and wherein the virtual object is an element of a boundary of the racetrack.

In some cases, the vehicle is predicted to collide with the virtual object when the vehicle moves away from an apex line presented within the display environment.

In some cases, the vehicle is predicted to collide with the virtual object when the vehicle moves within a threshold distance of the virtual object.

In some embodiments, a method performed by a computing system of a vehicle includes receiving instructions from a virtual user interface (VUI) worn by a driver of the vehicle and modifying operations of one or more components of the vehicle in response to the received instructions.

In some cases, the instructions identify an occurrence of a virtual action within a virtual environment displayed by the VUI to the driver of the vehicle, wherein the operations of the one or more components are modified based on the identified occurrence of the virtual action with the virtual environment.

In some cases, modifying the operations of the one or more components of the vehicle includes modifying a braking operation of the vehicle to slow down the vehicle.

In some cases, modifying the operations of the one or more components of the vehicle includes modifying a braking operation of the vehicle to speed up the vehicle.

In some cases, modifying the operations of the one or more components of the vehicle includes modifying a steering operation of the vehicle to adjust a direction of the movement of the vehicle.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or”, in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the technology may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

From the foregoing, it will be appreciated that specific embodiments have been described herein for purposes of illustration, but that various modifications may be made without deviating from the spirit and scope of the embodiments. Accordingly, the embodiments are not limited except as by the appended claims.

What is claimed is:

1. A driving simulation system, comprising:
a virtual racing module that is configured to:
present a virtual racing environment to a driver of a real-world vehicle,
wherein the virtual racing environment includes a racetrack via which the driver of the vehicle moves within the virtual racing environment;
present one or more virtual objects within the virtual racing environment; and
determine occurrences of virtual actions between the driver of the vehicle and the presented one or more virtual objects within the virtual racing environment; and
a vehicle operation module that is configured to modify operation of the real-world vehicle in response to an occurrence of a virtual action within the virtual racing environment.

2. The driving simulation system of claim 1, wherein the one or more virtual objects include avatars representing virtual vehicles also moving via the racetrack within the virtual racing environment; and
wherein the occurrence of the virtual action within the virtual racing environment includes a virtual collision between the driver of the vehicle and one of the avatars representing virtual vehicles.

3. The driving simulation system of claim 1, wherein the one or more virtual objects include displayed objects representing portions of the racetrack within the virtual racing environment; and
wherein the occurrence of the virtual action within the virtual racing environment includes a virtual collision between the driver of the vehicle and one of the displayed objects representing the portions of the racetrack.

4. The driving simulation system of claim 1, wherein the virtual racing module determines an occurrence of a virtual action when the driver of the vehicle moves away from an apex line displayed on the racetrack via which the driver of the vehicle moves within the virtual racing environment.

5. The driving simulation system of claim 1, wherein the virtual racing module determines an occurrence of a virtual action when the driver of the vehicle within a threshold distance to one or more virtual objects within the virtual racing environment.

6. The driving simulation system of claim 1, wherein the vehicle operation module causes a braking function of the vehicle to slow a current speed of the vehicle in response to the occurrence of the virtual action within the virtual racing environment.

7. The driving simulation system of claim 1, wherein the vehicle operation module causes a steering function of the vehicle to adjust a direction of movement of the vehicle in response to the occurrence of the virtual action within the virtual racing environment.

8. The driving simulation system of claim 1, wherein the vehicle operation module causes a steering function of the vehicle to adjust a direction of movement of the vehicle and a braking function of the vehicle to slow a current speed of the vehicle in response to the occurrence of the virtual action within the virtual racing environment.

9. The driving simulation system of claim 1, wherein the virtual racing module is part of a helmet worn by the driver of the vehicle that presents the virtual racing environment as an augmented reality experience via a heads-up-display supported by the helmet.

10. The driving simulation system of claim 1, wherein the vehicle operation module is part of a computing system of the vehicle.

11. A method performed by a virtual user interface (VUI) interacted with by a driver of a real-world vehicle, the method comprising:
presenting a virtual object within a display environment of an augmented reality display presented to the driver of the vehicle via the VUI;
determining the real-world vehicle is predicted to collide within the virtual object within the display environment; and
in response to the predicted collision between the real-world vehicle and the virtual object, transmitting information associated with the predicted collision to a computing system of the real-world vehicle.

12. The method of claim 11, wherein the display environment includes a racetrack via which the driver of the vehicle moves; and wherein the virtual object is another vehicle moving within the racetrack.

13. The method of claim 11, wherein the display environment includes a racetrack via which the driver of the real-world vehicle moves; and wherein the virtual object is an element of a boundary of the racetrack.

14. The method of claim 11, wherein the real-world vehicle is predicted to collide with the virtual object when the vehicle moves away from an apex line presented within the display environment.

15. The method of claim 11, wherein the real-world vehicle is predicted to collide with the virtual object when the real-world vehicle moves within a threshold distance of the virtual object.

16. A non-transitory computer-readable medium whose contents, when executed by a computing system of a real-world vehicle, cause the real-world vehicle to perform a method, the method comprising:
receiving instructions from a virtual user interface (VUI) interacted with by a driver of the real-world vehicle; and
modifying operations of one or more components of the real-world vehicle in response to the received instructions.

17. The computer-readable medium of claim 16, wherein the instructions identify an occurrence of a virtual action within a virtual environment displayed by the VUI to the driver of the real-world vehicle; and
wherein the operations of the one or more components are modified based on the identified occurrence of the virtual action with the virtual environment.

18. The computer-readable medium of claim 16, wherein modifying the operations of the one or more components of the real-world vehicle includes modifying a braking operation of the real-world vehicle to slow down the real-world vehicle.

19. The computer-readable medium of claim 16, wherein modifying the operations of the one or more components of the real-world vehicle includes modifying a braking operation of the real-world vehicle to speed up the real-world vehicle.

20. The computer-readable medium of claim 16, wherein modifying the operations of the one or more components of the real-world vehicle includes modifying a steering operation of the real-world vehicle to adjust a direction of the movement of the real-world vehicle.
